(19) United States
(12) Patent Application Publication
(10) Pub. No.: US 2018/0131918 A1
(43) Pub. Date: May 10, 2018

(54) THERMAL VIDEO SYSTEM, METHOD AND COMPUTER-READABLE MEDIUM

(71) Applicant: AdvanceWorx Inc., Sudbury (CA)

(72) Inventor: Michael Dolinar, Sudbury (CA)

(73) Assignee: AdvanceWorx Inc., Sudbury (CA)

(21) Appl. No.: 15/805,000

(22) Filed: Nov. 6, 2017

(30) Foreign Application Priority Data
Nov. 7, 2016 (CA) 2947712

(51) Int. Cl. H04N 9/64; H04N 5/33; H04N 5/232

(52) U.S. Cl. CPC H04N 9/64; G06F 3/04847; H04N 5/23293; H04N 5/33

(57) ABSTRACT

Disclosed herein are a system, method and computer-readable medium that receive temperature data for a plurality of frames from an infrared detector array, store the temperature data for the plurality of frames in one or more data files, retrieve the data file(s) in response to one or more user commands specifying one or both of a palette selection and temperature range parameters, generate image data by applying the palette selection and temperature range parameters and display a thermal video based on the image data. This enables a recorded thermal video to be replayed with different palettes or ranges.

### CROSS-REFERENCE TO RELATED APPLICATIONS

The present application claims priority under 35 U.S.C. § 119 to Canadian Patent Application No. 2,947,712, filed Nov. 7, 2016. The contents of this application are incorporated herein by reference in their entirety.

### TECHNICAL FIELD

The present invention relates generally to thermal imaging and, more particularly, to techniques for manipulating thermal video.

### BACKGROUND

Thermal imaging cameras have an infrared-sensitive detector array of infrared sensors. The thermal imaging cameras convert incident infrared radiation into visible images, or thermograms, using a palette of colours that represent a temperature gradient. A thermal video can be created using a series of images, i.e. image frames.

Existing thermal video technologies save the thermal image frames in a standard video format without retaining the original temperature data from which the image frames were rendered. Therefore, once a thermal video has been made, the palette and temperature parameters of the thermal video cannot be adjusted or otherwise manipulated to alter the thermal video. Thus, if a thermal video has been recorded using parameters that are inappropriate for the temperatures to be imaged, the thermal video may have limited value.

Accordingly, it would be highly desirable to provide a thermal video technology to address these shortcomings.

### SUMMARY

The following presents a simplified summary of some aspects or embodiments of the invention in order to provide a basic understanding of the invention. This summary is not an extensive overview of the invention. It is not intended to identify key or critical elements of the invention or to delineate the scope of the invention. Its sole purpose is to present some embodiments of the invention in a simplified form as a prelude to the more detailed description that is presented later.

In general, the present invention provides a thermal video system, method and computer-readable medium that stores temperature data from an infrared-sensitive detector array in one or more data files to enable regeneration of a thermal video using different palettes and range parameters.

In accordance with one inventive aspect of the present disclosure, a thermal video system includes a thermal video camera comprising an infrared-sensitive detector array for converting incident infrared radiation into temperature data for a plurality of frames and a computing device. The computing device has a data communication port communicatively connected to the thermal video camera for receiving the temperature data, a memory to store the temperature data in one or more data files, a user input device to receive one or more user commands specifying one or both of a palette selection and temperature range parameters, a processor configured to retrieve the one or more data files in response to the user command and to generate image data by applying the palette selection and temperature range parameters, and a display for displaying a thermal video based on the image data.

In accordance with another inventive aspect of the present disclosure, a computer-readable medium comprises instructions in executable code which when stored in a memory of a computing device and executed by a processor of the computing device cause the computing device to receive temperature data for a plurality of frames from an infrared detector array and to store the temperature data for the plurality of frames in one or more data files. The computer-readable medium comprises instructions to retrieve the one or more data files in response to one or more user commands specifying one or both of a palette selection and temperature range parameters, to generate image data by applying the palette selection and temperature range parameters, and to display a thermal video based on the image data.

In accordance with yet another inventive aspect of the present disclosure, a computer-implemented method entails steps, acts or operations of receiving, by a computing device, temperature data for a plurality of frames from an infrared detector array and storing, in a memory of the computing device, the temperature data for the plurality of frames in one or more data files. The method further entails retrieving the one or more data files in response to one or more user commands specifying one or both of a palette selection and temperature range parameters, generating image data by applying the palette selection and temperature range parameters and displaying a thermal video based on the image data.

### BRIEF DESCRIPTION OF THE DRAWINGS

Further features and advantages of the present technology will become apparent from the following detailed description, taken in combination with the appended drawings, in which:

FIG. 1 is a schematic depiction of a thermal video system in accordance with an embodiment of the present invention;

FIG. 2 is a schematic depiction of a computing device executing code of a computer-readable medium in accordance with an embodiment of the present invention; and

FIG. 3 is a flowchart depicting steps of a computer-implemented method in accordance with an embodiment of the present invention.

It will be noted that throughout the appended drawings, like features are identified by like reference numerals.

### DETAILED DESCRIPTION

In general, the present invention provides a thermal video system, method and computer-readable medium that saves temperature data in one or more data files to enable regeneration of a thermal video using different palette or range parameters. Exemplary embodiments of this invention are illustrated in the figures and described below. It will be appreciated that the invention may include other embodiments and variants that implement the inventive concept.

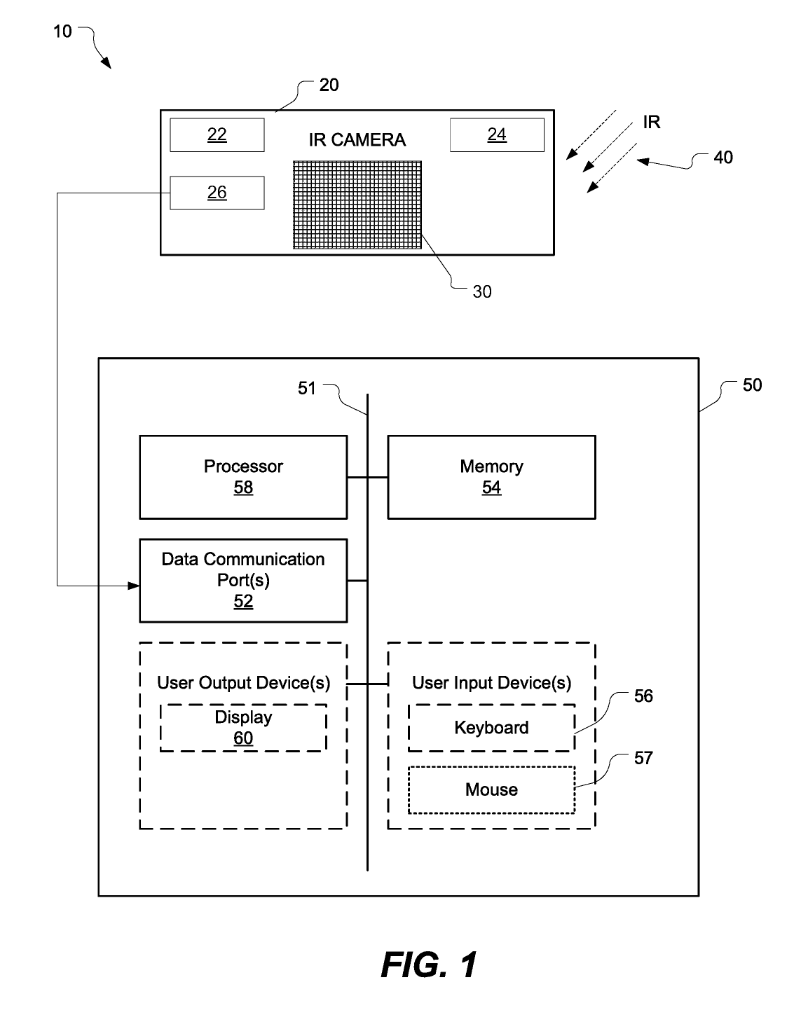

In the embodiment illustrated by way of example in FIG. 1, a thermal video system generally designed by reference numeral 10 includes a thermal video camera 20 comprising an infrared-sensitive detector array 30 (or “sensor array”) for converting incident infrared radiation 40 into temperature data for a plurality of frames. In the embodiment of FIG. 1, the camera includes a power module 22 (which may include an external power connector or socket and/or a battery), signal-conditioning circuitry 24 (which may include one or more amplifier, filter, analog-to-digital converter, encoder, etc.) and an output data interface 26 for outputting a data signal. The output data interface 26 may be a wired interface or a wireless interface. The camera 20 may further include a shutter, lens, optical low-pass filter and/or infrared filter to focus and filter the incident infrared radiation before the infrared radiation impinges on the sensor array 30. The camera 20 may be any suitable thermal imager including, for example, any suitable charge-coupled device (CCD) or complementary metal-oxide-semiconductor (CMOS) device. The camera 20 may be a forward-looking infrared (FLIR) camera.

As illustrated by way of example in FIG. 1, the thermal video system 10 also includes a computing device 50 connected by wired or wireless connection to the camera 20. The computing device 50 has a data communication port 52 communicatively connected to the output data interface 26 of the thermal video camera 20 for receiving the temperature data. The communication port 52 may be a modem, Ethernet port, network interface card (or network adapter), Wi-Fi® transceiver, Bluetooth® transceiver, cellular transceiver or any other wireless transceiver. The computing device 50 includes a memory 54 to store the temperature data in one or more data files. The memory 54 may include volatile and non-volatile memory. Volatile memory may include random access memory (RAM), DRAM, DDR SDRAM, SRAM, or equivalent. Non-volatile memory may include read-only memory (ROM), Mask ROM, PROM, EPROM, EEPROM, NVRAM, Flash memory, Solid-state storage, nvSRAM, FeRAM, MRAM, PRAM or equivalent. Memory may also include magnetic tape, hard disk drive, optical disc drive, or any other suitable data-storage device or medium.

In one embodiment, the computing device 50 includes a user input device, e.g. a keyboard 56, a mouse 57, speech recognition module, etc. to receive one or more user commands specifying one or both of a palette selection and temperature range parameters. The computing device 50 further includes a processor 58 configured to retrieve the one or more data files from the memory 54 in response to the user command and to generate image data by applying the palette selection and temperature range parameters. In one embodiment, the computing device 50 further includes an output device such as a display 60 for displaying a thermal video based on the image data. The display 60 may be an LCD, LED, or OLED display screen or any equivalent display screen capable of outputting the thermal video in colour. Any other display technology (e.g. CRT, projector) may be used to display the thermal video. In another embodiment, instead of displaying the thermal video, the computing device 50 may output the image data to a storage medium or transmitted to another computing device for storage and/or display and/or analysis. In this other embodiment, the computing device 50 may not have the user input and output devices shown by way of example in FIG. 1.

In yet another embodiment, the computing device 50 may be configured or programmed to operate autonomously. For example, the computing device 50 may be configured or programmed to automatically apply (i.e. without contemporaneous user input) a palette to a predetermined range appropriate for a particular application, e.g. visual detection of human body temperatures.

The computing device 50 may be a desktop computer, laptop computer, tablet, phablet, mobile device, wireless communications device, smart phone, PDA, or smart TV or any other suitable computer-type machine capable of outputting the thermal video. It will be appreciated that the expression “computing device” shall be construed as encompassing any group or cluster of computing connected or networked computing devices, including a local area network (LAN), wide area network (WAN), etc. For example, in one implementation, a first computing device may store the one or more data files and a second (connected) computing device may generate and display the rendered images.

The computing device 50 is configured to read and execute computer-readable code from a computer-readable medium, e.g. the memory 54 or from any external memory or storage device to which the computing device is connected or networked. The computer-readable medium comprises instructions in executable code which when stored in the memory 54 of the computing device 50 and executed by the processor 58 of the computing device 50 cause the computing device 50 to receive temperature data for a plurality of frames from an infrared detector array and to store the temperature data for the plurality of frames in one or more data files. The computer-readable medium comprises instructions to retrieve the one or more data files in response to one or more user commands specifying one or both of a palette selection and temperature range parameters, to generate image data by applying the palette selection and temperature range parameters, and to display a thermal video based on the image data.

In another embodiment, the computing device 50 may be a microcontroller with integrated firmware. In this embodiment, the computing device may not necessarily have a display or be networked. In this embodiment, the image data may be output to a memory card, for example, for later viewing.

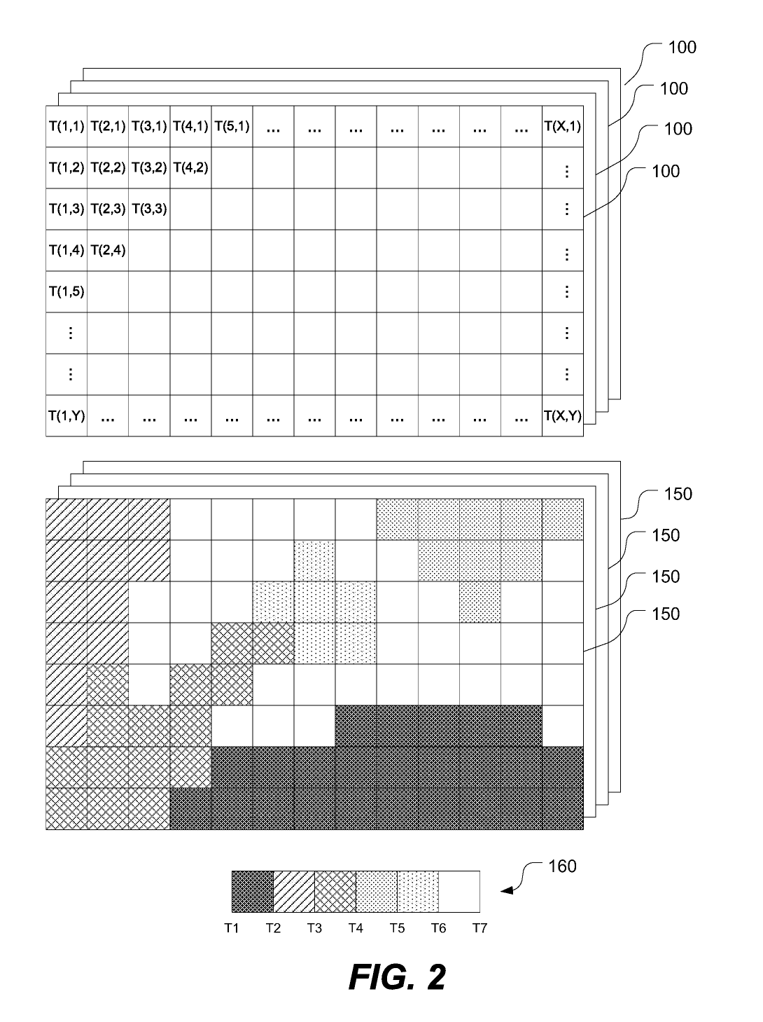

FIG. 2 depicts schematically a plurality of temperature data files denoted 100 each of which contains a two-by-two array of temperature data. Each temperature data point corresponds to a respective sensor of the sensor array. The temperature data T(X,Y) may thus be stored for an array having X rows and Y columns of sensors. Any suitable data structure or format may be used to store the data in the data file(s). By applying a palette (which may be a colour palette or a greyscale shading palette or any equivalent means of graphical representation), a set of video frames 150 may be generated and then rendered. For example, the palette 160 may be adjustable by setting ranges T1, T2, T3, T4, T5, T6, T7. The number of different colours and their ranges may be varied, as will be appreciated.

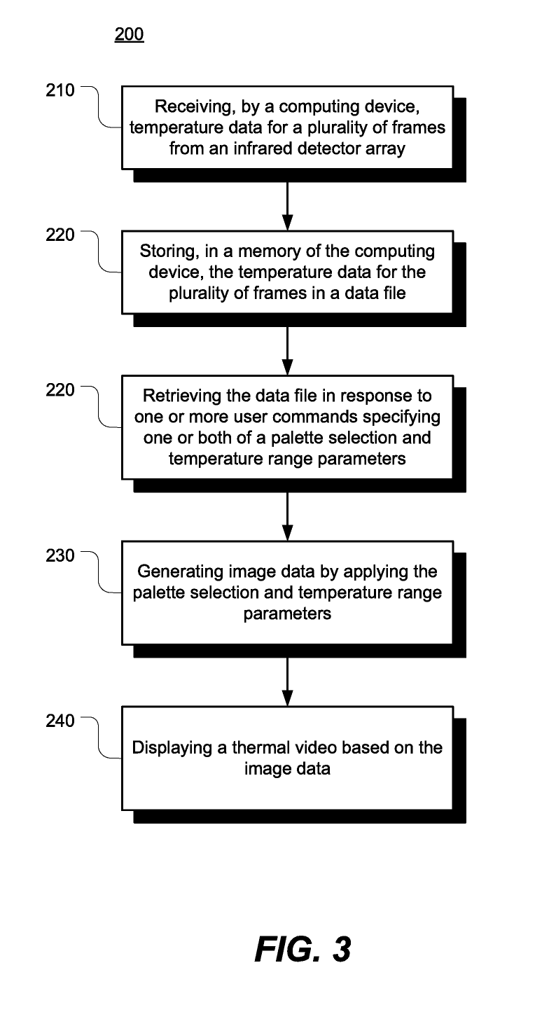

As depicted in the flowchart presented in FIG. 3, a computer-implemented method 200 entails a step, act or operation 210 of receiving, by the computing device 50, temperature data for a plurality of frames from an infrared detector array and a step, act or operation 220 of storing, in a memory of the computing device, the temperature data for the plurality of frames in one or more data files. The method 200 further entails a step, act or operation 220 of retrieving the data file(s) in response to one or more user commands specifying one or both of a palette selection and temperature range parameters, a step, act or operation 230 of generating image data by applying the palette selection and temperature range parameters and a step, act or operation 240 of displaying a thermal video based on the image data.

A computer-readable medium can be any means that contain, store, communicate, propagate or transport the program for use by or in connection with the instruction execution system, apparatus or device. The computer-readable medium may be electronic, magnetic, optical, electromagnetic, infrared or any semiconductor system or device. For example, computer executable code to perform the methods disclosed herein may be tangibly recorded on a non-transitory computer-readable medium including, but not limited to, a CD-ROM, DVD, RAM, ROM, EPROM, Flash Memory or any suitable memory card, etc. The method may also be implemented in hardware. A hardware implementation might employ discrete logic circuits having logic gates for implementing logic functions on data signals, an application-specific integrated circuit (ASIC) having appropriate combinational logic gates, a programmable gate array (PGA), a field programmable gate array (FPGA), etc.

It is to be understood that the singular forms “a”, “an” and “the” include plural referents unless the context clearly dictates otherwise. Thus, for example, reference to “a device” includes reference to one or more of such devices, i.e. that there is at least one device. The terms “comprising”, “having”, “including” and “containing” are to be construed as open-ended terms (i.e., meaning “including, but not limited to,”) unless otherwise noted. All methods described herein can be performed in any suitable order unless otherwise indicated herein or otherwise clearly contradicted by context. The use of examples or exemplary language (e.g. “such as”) is intended merely to better illustrate or describe embodiments of the invention and is not intended to limit the scope of the invention unless otherwise claimed.

This invention has been described in terms of specific embodiments, implementations and configurations which are intended to be exemplary only. Persons of ordinary skill in the art will appreciate, having read this disclosure, that many obvious variations, modifications and refinements may be made without departing from the inventive concept(s) presented herein. The scope of the exclusive right sought by the Applicant(s) is therefore intended to be limited solely by the appended claims.

1. A thermal video system comprising:
a thermal video camera comprising an infrared-sensitive detector array for converting incident infrared radiation into temperature data for a plurality of frames;
a computing device having:
a data communication port communicatively connected to the thermal video camera for receiving the temperature data;
a memory to store the temperature data in one or more data files;
a user input device to receive one or more user commands specifying one or both of a palette selection and temperature range parameters;
a processor configured to retrieve the one or more data files in response to the user command and to generate image data by applying the palette selection and temperature range parameters; and
a display for displaying a thermal video based on the image data.

2. The system of claim 1 wherein the processor of the computing device cooperates with the display to present a range manipulation tool enabling the range to be locked, unlocked or set manually.

3. The system of claim 1 wherein the processor of the computing device cooperates with the display to present a palette adjustment tool.

4. The system of claim 1 wherein the processor of the computing device cooperates with the display to present an analysis tool for analyzing the temperature data.

5. The system of claim 1 wherein the processor of the computing device cooperates with the display to present a virtual thermometer tool to add, remove or move thermometers that display a temperature of a point or region displayed onscreen.

6. A computer-readable medium comprising instructions in executable code which when stored in a memory of a computing device and executed by a processor of the computing device cause the computing device to:
receive temperature data for a plurality of frames from an infrared detector array;
store the temperature data for the plurality of frames in one or more data files;
retrieve the one or more data files in response to one or more user commands specifying one or both of a palette selection and temperature range parameters;
generate image data by applying the palette selection and temperature range parameters; and
display a thermal video based on the image data.

7. The computer-readable medium of claim 6 further comprising code to cause the computing device to present a range manipulation tool enabling the range to be locked, unlocked or set manually.

8. The computer-readable medium of claim 6 further comprising code to cause the computing device to present a palette adjustment tool.

9. The computer-readable medium of claim 6 further comprising code to cause the computing device to present an analysis tool for analyzing the temperature data.

10. The computer-readable medium of claim 6 further comprising code to cause the computing device to present a virtual thermometer tool to add, remove or move thermometers that display a temperature of a point or region displayed onscreen.

11. A computer-implemented method comprising:
receiving, by a computing device, temperature data for a plurality of frames from an infrared detector array;
storing, in a memory of the computing device, the temperature data for the plurality of frames in one or more data files;
retrieving the one or more data files in response to one or more user commands specifying one or both of a palette selection and temperature range parameters;
generating image data by applying the palette selection and temperature range parameters; and
displaying a thermal video based on the image data.

12. The computer-implemented method of claim 11 further comprising displaying a range manipulation tool enabling the range to be locked, unlocked or set manually.

13. The computer-implemented method of claim 11 further comprising displaying a palette adjustment tool.

14. The computer-implemented method of claim 11 further comprising displaying an analysis tool for analyzing the temperature data.

15. The computer-implemented method of claim 11 further comprising displaying a virtual thermometer tool to add, remove or move thermometers that display a temperature of a point or region displayed onscreen.
